(19) United States
(12) Patent Application Publication
(10) Pub. No.: US 2006/0294019 A1
(43) Pub. Date: Dec. 28, 2006

(54) On demand business model to reuse software license

(75) Inventors: Richard A. Dayan, Wake Forest, NC (US); Richard W. Cheston, Cary, NC (US); Daryl C. Cromer, Apex, NC (US); Howard J. Locker, Cary, NC (US); Randall S. Springfield, Chapel Hill, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: Lenovo (Singapore) Pte. Ltd., Singapore (SG)

(21) Appl. No.: 11/159,044

(22) Filed: Jun. 22, 2005

(51) Int. Cl. G06Q 99/00

(52) U.S. Cl. 705/59

(57) ABSTRACT

A technique is disclosed for storing an electronic record of the existence of licenses available for use in a network of computers and the deployment status of programs covered by the licenses. License tokens are stored on a license server, and the stored license tokens are used to validate the deployment of applications stored on clients associated with the license server. The license server maintains the license tokens for all licensed applications used by the associated clients and maintains a license file for each client. Periodically, the license file containing token data is sent to the pre-boot environment of each client in the system, e.g., by a synching process. A license-maintenance application residing in the pre-boot environment of each client validates the applications stored on the client by comparing them with the token data in the license file upon the occurrence of a pre-boot process.

### BACKGROUND OF THE INVENTION

1. Field of the Invention

This invention relates to management of software licenses, particularly the management of software licenses in a large enterprise environment.

2. Description of the Related Art

With the advancement of computer technology proceeding at a lightning pace, computers are being replaced with great frequency. Older computers being replaced are typically donated to employees or non-profit organizations, sold, scrapped, or recycled. Many PC manufacturers even offer their customers the opportunity to recycle personal computers and other peripherals.

When a user decides to migrate from an old system to a newer system with more up-to-date technology, in many instances, applications that were being used on the old system will again be used on the new system. For example, a user may use Lotus Notes (International Business Machines Corporation) on the old system and may wish to use the same Lotus Notes program on the new system. Likewise, an office productivity suite, such as Microsoft Office (Microsoft Corporation) may well be used on the new system.

Typically, a license exists for each application used on the old system. In most cases, the license for the application is transferrable from an old PC to a new PC, as long as the licensed copy is removed from the old system prior to use on the new system. For an individual user, this license transfer may not present much of a difficulty. However, in a large corporation with multiple users, it is difficult to track the old licenses and maintain a running inventory of which licensed copies are deployed on which machines within the organization. In view of this administrative difficulty, many large corporations simply buy new applications and licenses for their new personal computers instead of reusing the existing licenses. This is cost-inefficient and can represent a significant cost to a large corporation.

Accordingly, what is needed is a license-maintenance method and system to track application licenses and their deployment automatically so that the licenses for applications that have been removed from unused machines can be reused on new or different existing machines.

### SUMMARY OF THE INVENTION

This invention is a system and method for storing an electronic record of the existence of licenses available for use in a network of computers and the deployment status of programs covered by the licenses. In a preferred embodiment, license tokens are stored on a license server, and the stored license tokens are used to validate the deployment of applications stored on clients associated with the license server. The license server maintains the license tokens for all licensed applications used by the associated clients and maintains a license file for each client. On a regular basis the license file containing token data is sent to the pre-boot environment of each client in the system, e.g., by a synching process. A license-maintenance application residing in the pre-boot environment of each client validates the applications stored on the client by comparing them with the token data in the license file upon the occurrence of a pre-boot process. If an application is found on the client that does not have an appropriate token data entry in the license file, corrective action may be taken.

When an application is voluntarily removed from a client by the user or IT administrator, on the next boot the application is identified as having been removed by the pre-boot environment (e.g., there will be a token data entry in the license file, but the program will not be found), and the license maintenance application informs the license server, and the license server then frees up the license token (and thus the license) for that instance of the application for use by another client and sends the client a new license file indicating this application is no longer on the client.

### BRIEF DESCRIPTION OF THE DRAWINGS

FIG. 1 is a block diagram illustrating the general architecture of the present invention;

FIG. 2 illustrates details of license-file storage;

FIG. 3 illustrates an example of a process performed in accordance with the present invention each time a client boots up;

FIG. 4 is a flowchart illustrating the installation process of an application that has not been previously installed on a client device; and

FIG. 5 illustrates an example of steps performed when an application is going to be removed from a client.

### DETAILED DESCRIPTION OF THE PREFERRED EMBODIMENTS

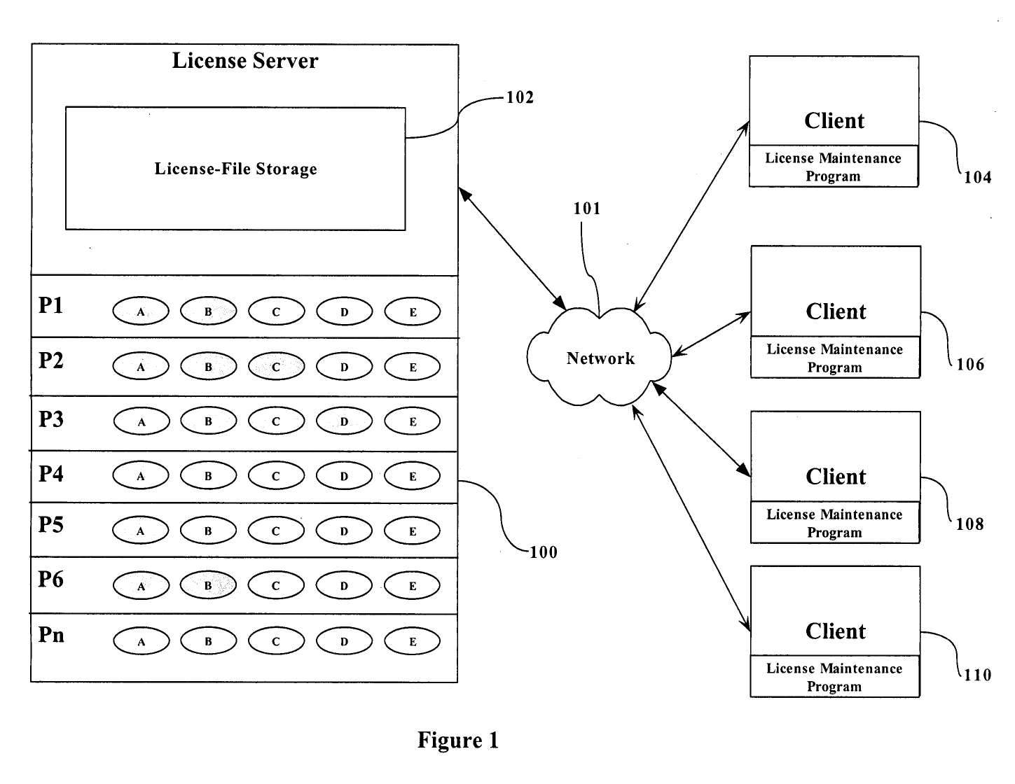

FIG. 1 is a block diagram illustrating the general architecture of a preferred embodiment of the present invention. A license server 100 is connected via a network 101 to a plurality of clients 104, 106, 108, and 110. License server 100 includes license-file storage 102 (described in more detail below) and also stores license tokens representing licenses available for use for multiple programs P1, P2, P3, P4, P5, P6, Pn.

For example, for each program P1-Pn, there are five license tokens, A-E, available for use by clients associated with server 100. Shaded license tokens in the example of FIG. 1 indicate license tokens that are currently associated with licenses assigned to clients. For example, for program P1 licenses, the licenses associated with tokens A and B are currently assigned to clients; for program P2 licenses, the licenses associated with tokens A, B, and C are currently assigned to clients, etc. When a license is in use, license server 100 is configured to flag a license token associated with that use so that only the authorized number of licensed copies of the software can be used by the clients.

It is understood that the architecture illustrated in FIG. 1 is for purposes of example only. Although only four clients are shown associated with license server 100, it is understood that the present invention is not limited to this number and many more clients may, and likely will, be served by license server 100. Similarly, although five license tokens (A-E) are shown as being available for each program for which licenses are being maintained by license server 100, it is understood that many more license tokens may be stored on license server 100.

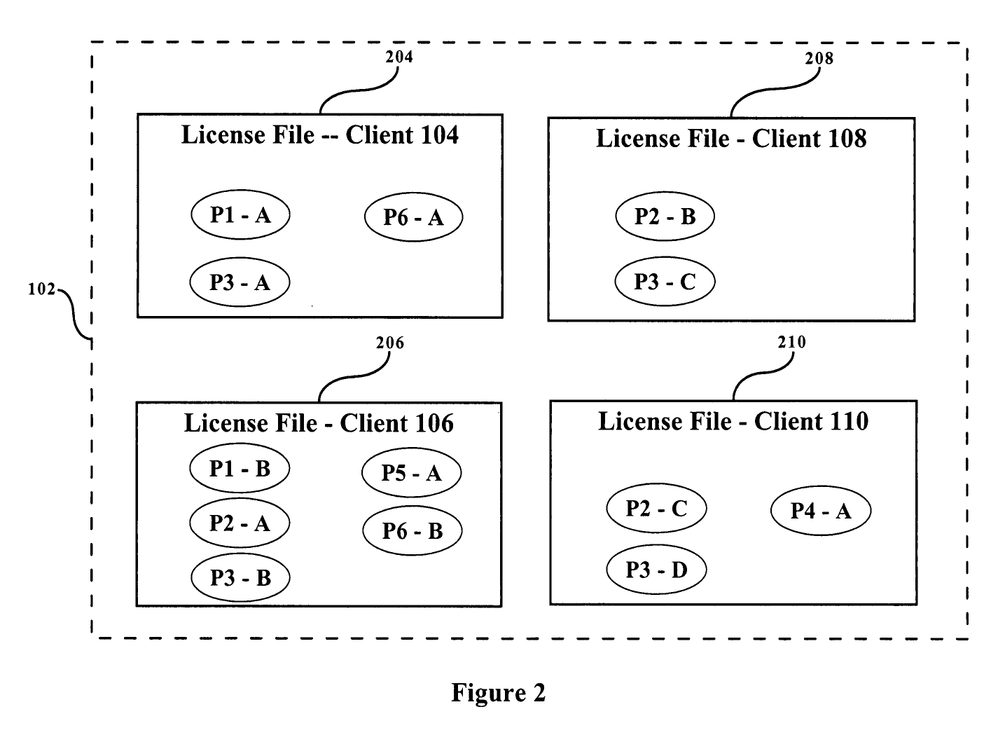

Details of license-file storage 102 are illustrated in FIG. 2. Referring to FIG. 2, license-file storage 102 stores a license file for each client 104, 106, 108, and 110. The license files are shared back and forth between the license server 100 and the clients, e.g., they are periodically synchronized in a well known manner so that each client contains its associated license information. As can be seen, tokens P1-A, P3-A, and P6-A are associated with client 104 by storing license token data entries for these tokens in license file 204, and thus, client 104 currently is licensed to utilize programs P1, P3, and P6. Similarly, license file 206 stores license token data entries P1-B, P2-A, P3-B, P5-A, and P6-B, thus giving client 106 license to use programs P1, P2, P3, P5 and P6. License file 208 stores license token data entries for client 108, specifically, license token data entries P2-B, and P3-C. Finally, license file 210 stores license token data entries for client 110, specifically, license token data entries P2-C, P3-D, and P4-A.

As noted above, the license files, including the license token data entries from license file storage 102, are periodically sent to the clients over the network. License server 100 is configured in a well-known manner (e.g., via software code, firmware, a combination of hardware and software, etc.) to enable the transfer of, i.e., to send, the license files to the preboot environment of their corresponding clients. The license file for a particular client is stored in a license-maintenance program residing in the pre-boot environment of each client. Thus, the license token data entries of license file 204 will be stored in the license-maintenance program of client 104, license token data entries of license file 206 will be stored in the license-maintenance program of client 106, the license token data entries of license file 208 will be stored in the license-maintenance program of client 108, and the license token data entries of license file 210 will be stored in the license-maintenance program of client 110.

Each license-maintenance program is configured to validate the applications stored on its corresponding client by reading the files on the client and comparing the results of this reading process with the license token data entries that have been sent to the client during synching with the license server. Whenever each of these clients begin a boot-up process, during the pre-boot operation, the license-maintenance program in the pre-boot environment will validate the programs installed on the client by comparing them with the license file data. The license-maintenance program is also configured to initiate corrective action when it finds unverified applications. If an application is loaded on one of the clients and there is not a corresponding entry in the license token data, the license-maintenance program can initiate protective action, e.g., it can make a request to the license server to arrange for the purchase of another license, remove the application from the client, deactivate it, etc. If desired, for statistical or for purpose of taking disciplinary action, this information can be conveyed back to the license server for reporting to a system administrator.

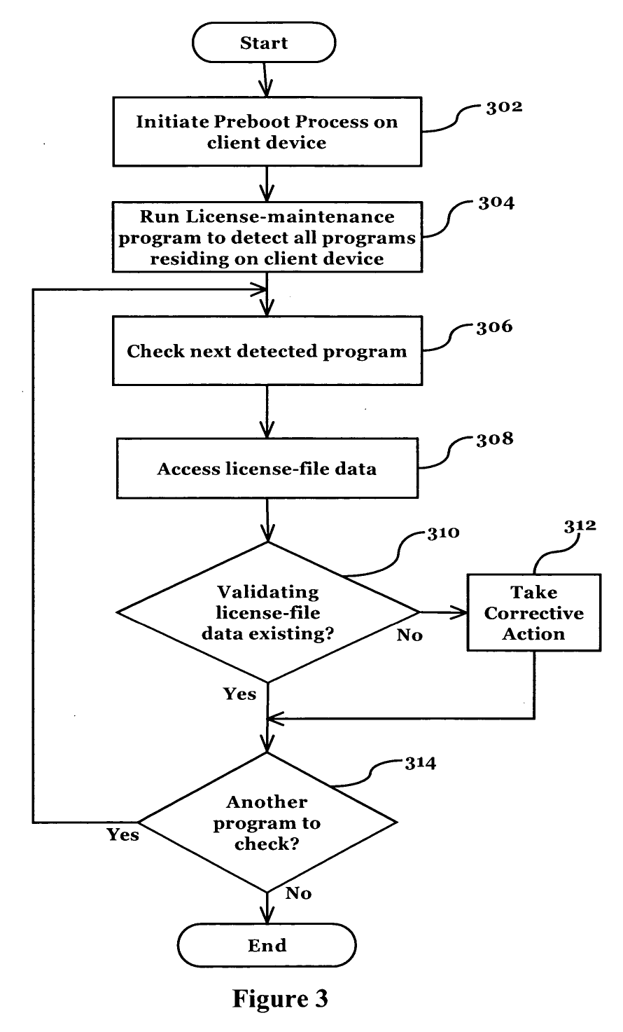

FIG. 3 illustrates an example of a process performed in accordance with the present invention each time a client boots up. Referring to FIG. 3, the process begins, and at step 302, the pre-boot process is initiated on the client device. At step 304, the license-maintenance program residing on the client is executed. This starts the process whereby, at step 306, the license maintenance program detects a program on the client device and, at step 308, accesses the license file to determine if validating license file data is present with respect to the detected program. At step 310, if validating license file data exists, the process proceeds to step 314. If, however, at step 310, no validating license file data exists, at step 312, corrective action is taken, and then the process proceeds to step 314.

The corrective action can take many forms. For example, a request can be generated by the license maintenance program for an additional license to be purchased. Alternatively, the license maintenance program can immediately remove the detected program from the client so that it can no longer be accessed. Another option is to have alerts sent to system administrators, or the program can be left on the client, but can be deactivated so that it cannot be used. The specific type of corrective action to be taken is a matter of design choice.

At step 314, a determination is made as to whether or not there are additional programs to be checked on the client device. If there are additional programs to be checked, the process proceeds back to step 306, where the next detected program is checked. If there are no additional programs to be checked, the process ends.

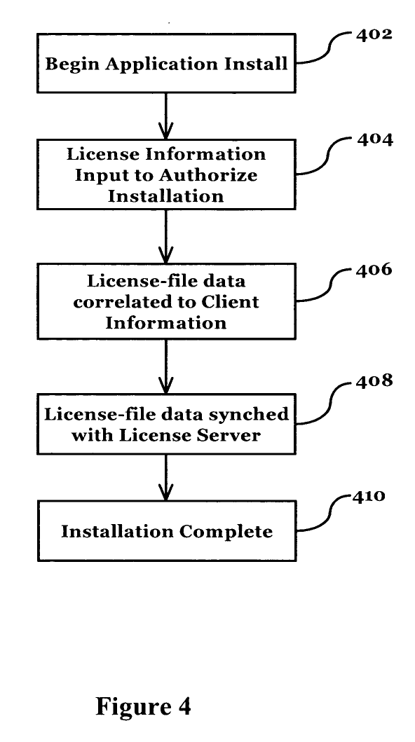

FIG. 4 is a flowchart illustrating the installation process of an application that has not been previously installed on a client device. At step 402, the installation process begins in an ordinary manner, i.e., by beginning a setup process for the software. As part of the setup process, at step 404 the license information is input to authorize the installation of the software. Typically this takes the form of the user inputting a license code of some kind which is verified before letting the installation continue. However, any license verification process can be utilized.

At step 406, the license information, correlated to the client information regarding the program, is stored as part of the license file data currently residing in the license maintenance program of the client device. At step 408, this information is conveyed to the license server, e.g., the license file data in the license-maintenance program is synched with the license server, thereby conveying to the license server the information regarding the newly-installed program. At step 410, the license server, now “aware” of the installation of one of the licensed programs, confirms that a license token exists on the license server corresponding to the newly-installed licensed version of the program. At this point, the installation process is complete. In this manner, the license server has confirmed that a license token exists for the new installation and maintains the license token information pertaining to this installation in the license file for the client.

If it turns out that there are no license tokens available for the installation, an alert is sent to the license server requesting a token. The administrator can then determine to purchase an additional license or find a client not using its license in order to free up a token. During the next pre-boot environment, an available token will be presented to the client which can then enable use of the licensed program.

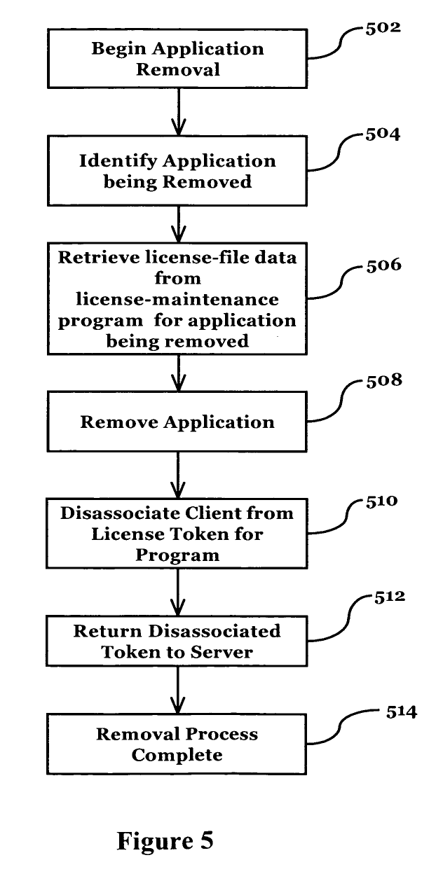

FIG. 5 illustrates an example of steps performed when an application is going to be voluntarily removed from a client. At step 502, the process begins, and at step 504 the application being removed is identified. For example, typically, the user or system administrator will run an “uninstall” program which will execute a series of processes to remove a particular program. The program being removed is identified at step 504 in this manner. At step 506, the license file data stored in the license-maintenance program of the client is modified to designate the license token data for the program being removed as being associated with a removed program. At step 508, the application is removed, and then during the next pre-boot environment the license file data is sent to the license server.

At step 510, the token associated with the removed program is disassociated with the client and is made available for use by others. The license file for the client is modified so that the license-file data for the now-disassociated program no longer is in the license file. Thus, on the next transmission of the license file data to the client, the license file data will not contain license file data for the disassociated program. If the user of the client has reinstalled the program, when the client goes through the pre-boot process, there will be no license file data for the improperly installed program, and corrective action can be taken. At step 514, the removal process is complete.

In some enterprise environments, when a client is surrendered by a particular user (e.g., the user leaves the company and leaves the client computer in his/her office and/or returns a laptop on their last day of employment) it is sent to an enterprise configuration center where it is completely cleaned of all files and then “common operating environment” (e.g., the enterprise image) is reloaded onto the computer before it is deployed to a new user. The cleaning of the files is typically performed by a disposal tool such as IBM's Secured Data Disposal (SSD). To ensure that the license server is made aware of the programs to be cleaned from the computer (and thus “return” the tokens for the licensed programs on the computer for reuse), the present invention can be implemented as a plug-in (or integrated directly) to the disposal program. Configured in this manner, after the disposal program reads the programs to be removed, but before the computer is actually wiped clean (which could dispose of the pre-boot environment of the client), the disposal program can connect to the license server to make it aware as to which licensed programs are being removed, allowing the tokens for these programs to be made available for new installations of the same program.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of the license server and/or any clients using the system. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A system for allocation of software licenses, comprising:
a license server storing license data for valid licenses deployable to clients communicating with said license server;
one or more clients capable of communicating with said license server, each of said clients including a license maintenance program operable in a preboot environment, said license maintenance program enforcing predetermined license policies based on license data obtained from said license server.

2. The system of claim 1, further comprising:
synchronization means for facilitating communications between said license server and each of said clients.

3. The system of claim 2, wherein said license data comprises a license file corresponding to each client, said license server comprising:
means for sending said license file to the preboot environment of its corresponding client during a synching process performed via said synchronization means.

4. The system of claim 3, wherein said license server stores license tokens for each licensed application useable by said clients, and wherein each license file contains token data identifying each licensed application assigned for deployment on its corresponding client.

5. The system of claim 4, wherein each of said license maintenance programs includes means for validating applications stored on its corresponding client with said token data, upon the occurrence of a preboot process.

6. The system of claim 5, wherein each of said license maintenance programs include means for initiating corrective action if an application stored on its corresponding client cannot be validated.

7. The system of claim 3, wherein each of said license maintenance programs include:
means for communicating to the license server the removal of a licensed program from a client, so that said license token data can be modified to reflect the availability to said one or more clients of the license for the removed licensed program.

8. A method for allocation of software licenses, comprising:
storing, on a license server, license data for valid licenses deployable to clients communicating with said license server;
configuring each client capable of communicating with said license server with a license maintenance program operable in a preboot environment; and
enforcing, using said license maintenance program, predetermined license policies based on license data obtained from said license server.

9. The method of claim 8, wherein said license data comprises a license file corresponding to each client, said method further comprising:
performing a synchronization process between said license server and each of said clients, thereby sending each license file to the preboot environment of its corresponding client.

10. The method of claim 9, further comprising:
storing license tokens on said license server for each licensed application useable by said clients, wherein each license file contains token data identifying each licensed application assigned for deployment on its corresponding client.

11. The method of claim 10, further comprising:
validating with said token data, via said license maintenance programs, applications stored on their corresponding clients, upon the occurrence of a preboot process.

12. The method of claim 11, further comprising:
initiating, using said license maintenance programs, corrective action if an application stored on a corresponding client cannot be validated.

13. The method of claim 9, further comprising:
communicating to the license server the removal of a licensed program from a client; and
modifying said license token data to reflect the availability of the license for the removed licensed program to said clients.

14. A computer program product recorded on computer-readable medium for allocating software licenses, comprising:
computer-readable means for storing, on a license server, license data for valid licenses deployable to clients communicating with said license server;
computer-readable means for configuring each client capable of communicating with said license server with a license maintenance program operable in a preboot environment; and
computer-readable means for enforcing, using said license maintenance program, predetermined license policies based on license data obtained from said license server.

15. The computer program product of claim 14, wherein said license data comprises a license file corresponding to each client, said computer program product further comprising:
computer-readable means for performing a synchronization process between said license server and each of said clients, thereby sending each license file to the preboot environment of its corresponding client.

16. The computer program product of claim 15, further comprising:
computer-readable means for storing license tokens on said license server for each licensed application useable by said clients, wherein each license file contains token data identifying each licensed application assigned for deployment on its corresponding client.

17. The computer program product of claim 16, further comprising:
computer-readable means for validating with said token data, via said license maintenance programs, applications stored on their corresponding clients, upon the occurrence of a preboot process.

18. The computer program product of claim 17, further comprising:
computer-readable means for initiating, using said license maintenance programs, corrective action if an application stored on a corresponding client cannot be validated.

19. The computer program product of claim 16, further comprising:
computer-readable means for communicating to the license server the removal of a licensed program from a client; and
computer-readable means for modifying said license token data to reflect the availability of the license for the removed licensed program to said clients.
